(19) United States
(12) Patent Application Publication
(10) Pub. No.: US 2012/0141151 A1
(43) Pub. Date: Jun. 7, 2012

(54) IMAGE FORMING APPARATUS AND TONER SUPPLYING METHOD

(75) Inventor: Yuichi Yokoyama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/220,897

(22) Filed: Aug. 30, 2011

Related U.S. Application Data
(60) Provisional application No. 61/420,572, filed on Dec. 7, 2010.

(30) Foreign Application Priority Data
Apr. 7, 2011 (JP) P2011-085000

(51) Int. Cl. G03G 15/00; G03G 15/16

(52) U.S. Cl. 399/43; 399/101

(57) ABSTRACT

An image forming apparatus includes: a first image forming unit including an image carrier, a developing device configured to develop an electrostatic latent image formed on the image carrier and to form a toner image on the image carrier, and a first cleaning unit configured to remove residual toner on the image carrier; a second image forming unit including an image carrier, a developing device having toner in which an external additive has a larger amount than in toner in a developing device of a first image forming unit, the developing device configured to develop an electrostatic latent image formed on an image carrier and to form a toner image on the image carrier, and a second cleaning unit configured to remove residual toner on the image carrier; a transfer body facing the first and second image forming units and configured to convey the toner images transferred respectively from the image carriers at the time of executing a printing process; and a control unit configured to control to transfer the toner image from the image carrier of the second image forming unit to the transfer body at a timing other than the printing process, to reversely transfer the transferred toner image to the image carrier of the first image forming unit, and to supply the reversely transferred toner to a first cleaning unit.

### CROSS-REFERENCE TO RELATED APPLICATIONS

This application is based upon and claims the benefit of priority from the prior U.S. Patent Application No. 61/420,572, filed on Dec. 7, 2010, the entire contents of which are incorporated herein by reference. This application is also based upon and claims the benefit of priority from the prior Japanese Patent Application No. 2011-085000, filed on Apr. 7, 2011, the entire contents of which are incorporated herein by reference.

### FIELD

Embodiments described herein relate to an image forming apparatus employing an electrophotographic process, and to a toner supplying method.

### BACKGROUND

There has been known an image forming apparatus which uses toner having the circularity close to the sphere and having a small particle size in order to form images with excellent image quality. However, use of the toner having the circularity close to the sphere and having a small particle size causes a problem that a cleaning performance of post-transfer residual toner on a photosensitive drum is degraded to leave the toner passing by a cleaning blade and the toner adhering to the photosensitive drum, for example.

### BRIEF DESCRIPTION OF THE DRAWINGS

FIG. 1 is a configuration diagram showing an image forming apparatus according to a first embodiment.

FIG. 2 is a configuration diagram showing an internal structure of the image forming apparatus according to the first embodiment.

FIG. 3 is a view showing toner characteristics of image forming units for colors according to the first embodiment.

FIG. 4 is a view showing bias conditions at the time of normal printing by the image forming unit according to the first embodiment.

FIG. 5 is a view showing toner supply according to the first embodiment.

FIG. 6 is a view showing bias conditions at the time of reverse transfer of the image forming units for the colors according to the first embodiment.

FIG. 7 is a block diagram showing a control system of the image forming apparatus according to the first embodiment.

FIG. 8 is a flowchart showing a timing of the reverse transfer according to the first embodiment.

FIG. 9 is a flowchart 1 showing the reverse transfer according to the first embodiment.

FIG. 10 is a flowchart 2 showing the reverse transfer according to the first embodiment.

FIG. 11 is a view showing reverse transfer of black toner onto a yellow photosensitive drum according to the first embodiment.

FIG. 12 is a view showing reverse transfer of black toner onto a cyan photosensitive drum according to the first embodiment.

FIG. 13 is a view showing reverse transfer of black toner onto a magenta photosensitive drum according to the first embodiment.

FIG. 14 is a configuration diagram showing an internal structure of the image forming apparatus according to a second embodiment.

FIG. 15 is a configuration diagram showing an internal structure of the image forming apparatus according to a third embodiment.

FIG. 16 is a configuration diagram showing an internal structure of the image forming apparatus according to a fourth embodiment.

FIG. 17 is a configuration diagram showing an internal structure of the image forming apparatus according to a fifth embodiment.

### DETAILED DESCRIPTION

An object regarding one aspect of embodiments is to prevent toner from passing by a cleaning blade or adhering to a photosensitive drum.

In view of the above circumstances, an image forming apparatus according to one aspect of embodiments comprises: a first image forming unit including an image carrier, a developing device configured to develop an electrostatic latent image formed on the image carrier and to form a toner image on the image carrier, and a first cleaning unit configured to remove residual toner on the image carrier; a second image forming unit including an image carrier, a developing device having toner in which an external additive has a larger amount than in toner in the developing device of the first image forming unit, the developing device configured to develop an electrostatic latent image formed on the image carrier and to form a toner image on the image carrier, and a second cleaning unit configured to remove residual toner on the image carrier; a transfer body facing the first and second image forming units and configured to convey the toner images transferred respectively from the image carriers at the time of executing a printing process; and a control unit configured to control to transfer the toner image from the image carrier of the second image forming unit to the transfer body at a timing other than the printing process, to reversely transfer the transferred toner image to the image carrier of the first image forming unit, and to supply the reversely transferred toner to the first cleaning unit.

Embodiments of an image forming apparatus will be described below with reference to the accompanying drawings.

### First Embodiment

A first embodiment of the present invention provides a tandem-type image forming apparatus, which provides toner characteristics of a specific image forming unit different from toner characteristics of other image forming units, and which reversely transfer the toner of the specific image forming unit onto photosensitive drums of the other image forming units.

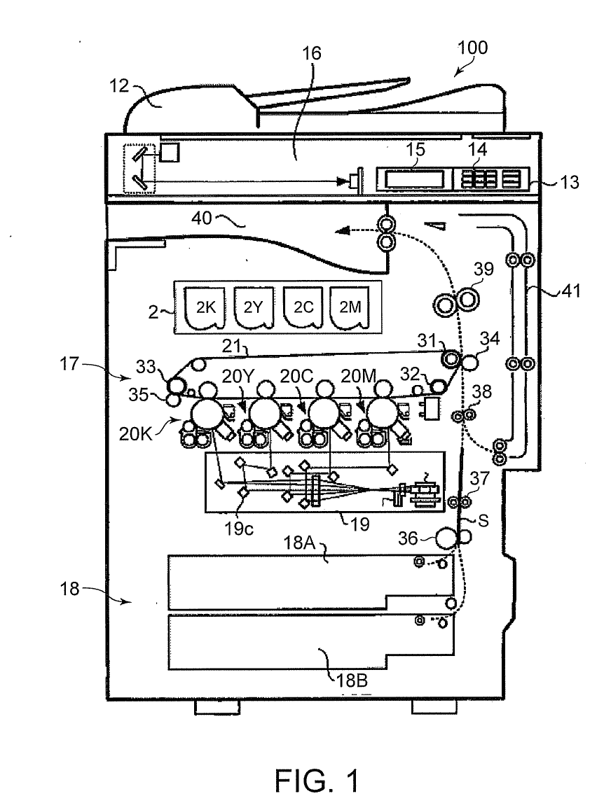

FIG. 1 is a configuration diagram showing an image forming apparatus according to the first embodiment. The image forming apparatus may be a MFP (multi-functional peripheral) serving as a multifunction device, a printer, a copier, and the like. In FIG. 1 a MFP 100 will be described below as an example.

The MFP 100 includes an automatic document feeder (ADF) 12, an operation panel 13, a scanner unit 16, a printer unit 17, a paper feeding unit (a paper cassette) 18, and a paper discharging unit 40.

The ADF 12 is provided open-ably and close-ably on a platen and conveys original documents automatically. The operation panel 13 includes an operating unit 14 provided with various keys, and a touch-panel display unit 15.

The scanner unit 16 is located below the ADF 12 and is configured to generate image data by reading an original document sent by the ADF 12 or an original document placed on the platen. The scanner unit 16 is an example of an input unit for an original document for printing. Alternatively, an original document created by a PC (personal computer) serving as an external terminal can be received through an input unit including an external input I/F.

The paper feeding unit 18 includes multiple cassettes 18A and 18B for containing sheets S in various sizes. The paper discharging unit 40 houses discharged sheets S after forming images thereon.

The printer unit 17 is provided with image forming units to be described later, a laser exposure device, and the like and is configured to process the image data read with the scanner unit 16 or the image data created with the PC and the like and to form an image on a sheet S (a printing process). The sheet with the image formed thereon by the printer unit 17 is discharged to the paper discharging unit 40. The printer unit 17 is a tandem-type color laser printer, for example, and is configured to form the image by scanning imager carriers (photosensitive drums) of the image forming units with a laser beam from a laser exposure device 19.

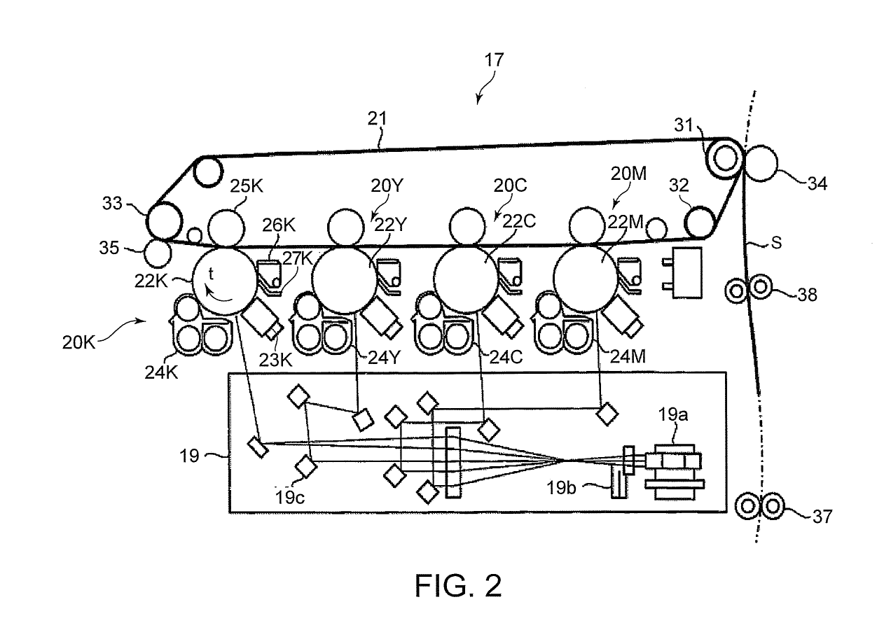

The laser exposure device 19 is provided with a polygon mirror 19a, a focusing lens system 19b, and mirrors 19c, and is configured to scan photosensitive drums 22 (see FIG. 2) in an axial direction with the laser beam emitted from a semiconductor laser element.

The printer unit 17 to be described later in detail with reference to FIG. 2 includes image forming units 20K, 20Y, 20C, and 20M in colors of black (K), yellow (Y), cyan (C), and magenta (M), respectively. The image forming units 20K, 20Y, 20C, and 20M are serially disposed below an intermediate transfer belt 21 (a transfer body) in the above-mentioned order from an upstream side to a downstream side in a moving direction of the intermediate transfer belt 21.

A toner cartridge 2 (a developer container unit) configured to supply toner to developing devices 24K, 24Y, 24C, and 24M (see FIG. 2) is provided above the image forming units 20. The toner cartridge 2 includes toner cartridges 2K, 2Y, 2C, and 2M for the respective colors of black, yellow, cyan, and magenta, which are located adjacent to one another.

Separation rollers 36 configured to take the sheets out of the paper feeding cassettes 18A and 18B, conveyor rollers 37, and resist rollers 38 are disposed in a paper feeding direction on the way from the paper feeding unit 18 to a secondary transfer roller 34 that contacts the intermediate transfer belt 21. A fixing device 39 is provided downstream in the paper feeding direction of the secondary transfer roller 34.

In addition, the paper discharging unit 40 and a reverse conveying path 41 are provided downstream of the fixing device 39. The sheets S with toner images fixed thereon by the fixing device 39 are discharged onto the paper discharging unit 40. The reverse conveying path 41 is configured to reverse the sheets S and to guide the sheets S toward the secondary transfer roller 34, and is used in the case of two-sided printing.

FIG. 2 is an enlarged view showing the printer unit 17 including the image forming units 20K, 20Y, 20C, and 20M. In the following, the configuration and operation of the image forming unit 20K will be described to represent the image forming units 20K (black), 20Y (yellow), 20C (cyan), and 20M (magenta) in the respective colors because all these image forming units employ similar configurations.

The image forming unit 20K includes a photosensitive drum 22K serving as an image carrier, and a charger 23K, a developing device 24K, a primary transfer roller 25K, a cleaner 26K, and a blade 27K are arranged in a rotating direction t around the photosensitive drum 22K. A laser beam modulated by image data corresponding to black is radiated for scanning from the laser exposure device 19 to an exposure position on the photosensitive drum 22K, thereby forming an electrostatic latent image on the photosensitive drum 22K being rotated.

The charger 23K of the image forming unit 20K charges the entire surface of the photosensitive drum 22K. The above-described laser beam is radiated onto the charged surface of this photosensitive drum to form the electrostatic latent image. The toner supplied from the toner cartridge 2K is agitated by an agitating unit included in the developing device 24K and is negatively charged. The developing device 24K supplies the black toner (the developer) to the photosensitive drum 22K by way of a developing roller to which a developing bias is applied. The electrostatic latent image on the photosensitive drum is developed (into a toner imaged) by the developer thus supplied. After, undergoing a primary transfer process to be described later, the cleaner 26K removes the toner (residual toner) not being transferred to the transfer belt 21 in the primary transfer process and remaining on the surface of the photosensitive drum 22K by use of the blade 27K.

In FIG. 1 and FIG. 2, the intermediate transfer belt 21 in an endless shape moves in a circulating manner. Semi-conductive polyimide, for example, is used for the intermediate transfer belt 21 in light of heat resistance and abrasion resistance. The intermediate transfer belt 21 is wound around a driving roller 31 and driven rollers 32 and 33 and is configured to face and contact photosensitive drums 22K, 22Y, 22C, and 22M. A primary transfer voltage is applied from the primary transfer roller 25K to a position of the intermediate transfer belt 21 facing the photosensitive drum 22K, whereby the toner image on the photosensitive drum 22K is primarily transferred to the intermediate transfer belt 21 (the primary transfer process). Due to this transfer process, images in the respective colors are transferred onto the intermediate transfer belt 21 so as to form a color transfer image (a toner image).

The secondary transfer roller 34 is disposed to face the driving roller 31 that lays the intermediate transfer belt 21 thereon. When a sheet S passes between the intermediate transfer belt 21 and the secondary transfer roller 34, a secondary transfer voltage is applied from the secondary transfer roller 34 to the sheet S, whereby the toner image on the intermediate transfer belt 21 is secondarily transferred to the sheet S (a secondary transfer process). A belt cleaner 35 configured to clean the toner (the residual toner) not transferred to the sheet S in the secondary transfer process is provided on the intermediate transfer belt 21 in the vicinity of the driven roller 33.

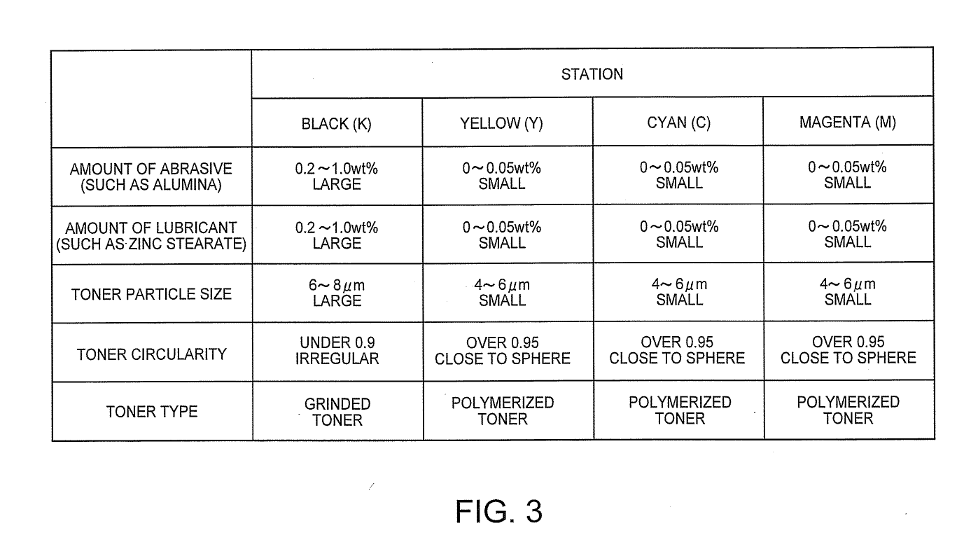

FIG. 3 is a view showing toner characteristics of the image forming units for the respective colors. The toner characteristics include an amount of abrasive, an amount of lubricant, toner particle size, toner circularity, and toner type, for example. The abrasive, is made of alumina, strontium titanate, silica or the like. Meanwhile, the lubricant is made of zinc stearate or the like.

As shown in FIG. 3, the toner characteristics of the black image forming unit 20K located on the uppermost stream side in the moving direction of the intermediate transfer belt 21 are different from those of other image forming units. The other image forming units are the yellow, cyan, and magenta image forming units 20Y, 20C, and 20M. For example, (1) the amount of the abrasive contained in the toner in the black image forming unit 20K is larger than that in the other image forming units 20Y, 20C, and 20M. For instance, the amount of the abrasive contained in the toner in the black image forming unit 20K is in a range from 0.2 to 1.0 wt % while the amount of the abrasive in the other image forming units 20Y, 20C, and 20M is in a range from 0 to 0.05 wt %.

(2) the amount of the lubricant contained in the toner in the black image forming unit 20K is larger than that in the other image forming units 20Y, 20C, and 20M. For instance, the amount of the lubricant contained in the toner in the black image forming unit 20K is in a range from 0.2 to 1.0 wt % while the amount of the lubricant in the other image forming units 20Y, 20C, and 20M is in a range from 0 to 0.05 wt %.

The amount of the abrasive or the amount of the lubricant is used in this embodiment. However, the amount of any external additive may be used for controlling the cleaning operation. For example, the external additive includes fluidizer, charge control agent, abrasive and lubricant generally. The fluidizer and charge control agent may be made of silica or oxidized titanium or the like. The abrasive may be made of alumina, strontium titanate, cerium oxide, silica or the like. The lubricant may be made of zinc stearate, magnesium stearate, calcium stearate, fluorinated resin or the like. The amount of any material as referred to above can be changed for controlling the cleaning operation.

Further details regarding toner with the external additive are described in Japanese laid open patent publication P2011-123346. The contents of which are hereby incorporated by reference.

(3) the size of toner particle contained in the black image forming unit 20K is larger than that in the other image forming units 20Y, 20C, and 20M. For example, a diameter is in a range from 6.0 to 8.0 μm. A diameter of toner particle in the other image forming units 20Y, 20C, and 20M is in a range from 4.0 to 6.0 μm, for instance.

The size of toner particle is measured by a coulter counter. 50,000 toner particles are measured; the diameter of toner particles is defined at 50 percent volume ratio to a total volume.

Further details are described in the title of “Electrophotography—Bases and Applications”, pages 669-673 published by CORONA PUBLISHING CO., LTD. in 1988. The contents of which are hereby incorporated by reference.

(4) The circularity of the toner in the black image forming unit 20K is more irregular than the circularities of the other image forming units 20Y, 20C, and 20M. For example, the toner circularity is equal to or below 0.9. Meanwhile, the toner circularities in the other image forming units 20Y, 20C, and 20M are equal to or above 0.95 so as to use roughly spherical toner.

The circularity is an index in regard to a projection image of a particle and can be measured based on the following calculating formula.

F=L1/L2

### F: Circularity.

L1: Circumferential length of the circle which is equal to a projection area of a particle.
L2: Circumferential length of a particle
Circularity can be measured by a flow system particle image analysis apparatus such as FPIA-2100 produced by Sysmex Corp, for example.

(5) The toner type of the black image forming unit 20K is grinded toner while the toner type of the other image forming units 20Y, 20C, and 20M are polymerized toner. The grinded toner particles have irregular sizes and shapes, whereas the polymerized toner particles have regular sizes and roughly spherical shapes. The polymerized toner also has smaller particle sizes.

The toner characteristics of the black image forming unit 20K and of the other image forming units 20Y, 20C, and 20M may be arranged otherwise by selecting and combining some of the above-described characteristics, namely, the amount of the abrasive, the amount of the lubricant, the toner particle size, the toner circularity, and the toner type.

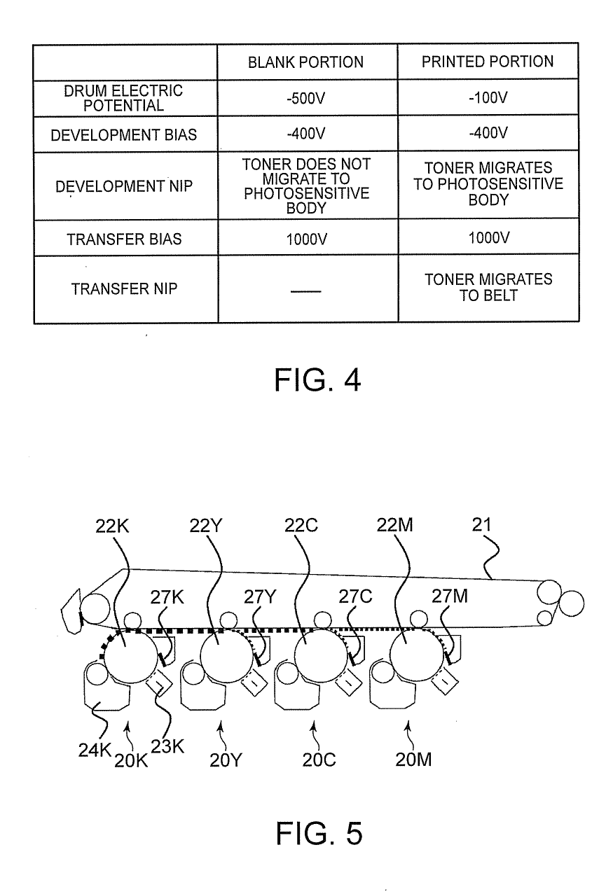

Biases and toner migration at the time of normal printing will be described below with reference to FIG. 4. FIG. 4 is a view showing bias conditions at the time of normal printing by the image forming unit.

At the time of normal printing, the photosensitive drum 22 is charged at −500 V by using the charger 23. An unprinted portion (a blank portion) is not exposed to the laser beam and a development bias is −400 V while retaining electric potential. Accordingly, the negatively biased toner does not migrate to the photosensitive drum 22. A printed portion is exposed to the laser beam and the electric potential is reduced to −100 V. At this time, if the development bias is −400 V, the negatively biased toner migrates to the photosensitive drum 22. Moreover, the toner further migrates to the intermediate transfer belt 21 by way of a transfer nip at a transfer bias of 1000V.

In the first embodiment, the toner in the black image forming unit 20K is supplied periodically to the other image forming units 20Y, 20C, and 20M having the different toner characteristics from those of the black toner by means of reverse transfer. For example, a certain amount of the black toner per unit number of sheets is supplied to the other image forming units 20Y, 20C, and 20M at the time of completing a print job. FIG. 5 is a view showing supply of the toner from the black image forming unit 20K to the other image forming units 20Y, 20C, and 20M.

A method of supplying the toner from the black image forming unit 20K to the other image forming units 20Y, 20C, and 20M will be described below. First, the black toner having the different toner characteristics from those in the other image forming units 20Y, 20C, and 20M is transferred (by solid printing, for example) from the black image forming unit 20K to the intermediate transfer belt 21 at a timing other than the printing process. The timing other than the printing process may be a timing between two sheets, a timing before image formation, a timing after completion of the print job, a timing to turn power on, or on standby. Next, the transfer bias of the yellow, cyan, and magenta image forming units 20Y, 20C, and 20M is a reverse transfer bias (a reverse bias) having an opposite polarity to the bias at the transfer in the primary transfer process (the transfer of the toner image from the photosensitive drum to the intermediate transfer belt) so as to reversely transfer (transfer in an reverse manner to the primary transfer process) the black toner on the intermediate transfer belt 21 to the respective photosensitive drums 22Y, 22C, and 22M (a reverse transfer process).

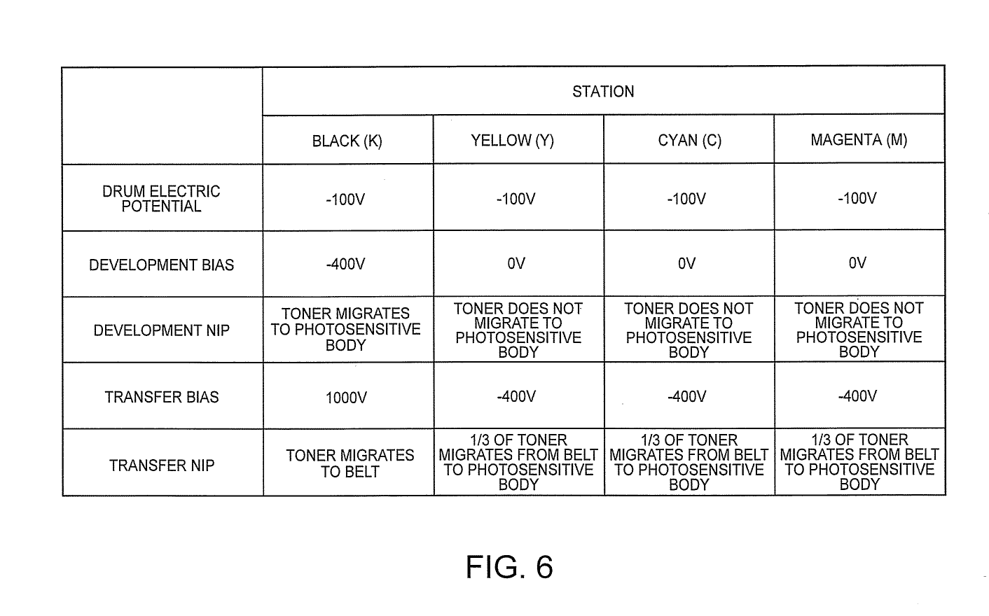

FIG. 6 shows bias conditions of the respective image forming units 20 at the time of the reverse transfer of the black toner to the photosensitive drums 22Y, 22C, and 22M. The electric potential of the photosensitive drums 22 for the respective colors is −100 V.

First, migration (development) of the toner to the photosensitive drum 22K and migration (transfer) of the toner from the photosensitive drum 22K to the intermediate transfer belt 21 will be described. The development bias of the black image forming unit 20K is −400 V and the transfer bias thereof is 1000 V. When the development bias is −400 V, the negatively charged toner migrates to the photosensitive drum 22K of −100 V. The toner migrating to the photosensitive drum 22K further migrates to the intermediate transfer belt 21 due to the transfer bias of 1000 V. The black toner transferred to the intermediate transfer belt 21 is conveyed downstream in the moving direction of the intermediate transfer belt 21 as shown in FIG. 5.

As shown in FIG. 6, the development bias of the image forming units 20Y, 20C, and 20M other than the black image forming unit is 0 V in the reverse transfer process. Accordingly, the toner in the respective color does not migrate from the developing devices 24Y, 24C, and 24M to the photosensitive drums 22Y, 22C, and 22M. The transfer bias of the yellow image forming unit 20Y is −400 V so as to transfer (reversely transfer) ⅓ of the black toner migrating to the intermediate transfer belt 21 on the upstream to the yellow photosensitive drum 22Y. The ⅔ of the black toner not migrating to the yellow photosensitive drum 22Y remains on the intermediate transfer drum 21 and is conveyed downstream.

Then, the transfer bias of the cyan image forming unit 20C is −400 V so as to transfer (reversely transfer) ⅓ of the black toner not migrating to the yellow photosensitive drum 22Y on the upstream to the cyan photosensitive drum 22C. The ⅓ stated herein means ⅓ of the amount migrating from the black image forming unit 20K to the intermediate transfer belt 21. The black toner not migrating to the cyan photosensitive drum 22C remains on the intermediate transfer drum 21 and is conveyed downstream.

The transfer bias of the magenta image forming unit 20M is −400 V so as to transfer (reversely transfer) the rest of the black toner not migrating to the cyan photosensitive drum 22C on the upstream to the magenta photosensitive drum 22M.

The black toner migrating to the yellow, cyan, and magenta photosensitive drums 22Y, 22C, and 22M is scraped off by the blades 27Y, 27C, and 27M for the respective colors. Adhesion of the toner in the respective colors to the photosensitive drums 22Y, 22C, and 20M and degradation in cleaning performances thereof are prevented by allowing the yellow, cyan, and magenta blades 27Y, 27C, and 27M to scrape off the black toner having the larger amounts of the abrasive and the lubricant and having the larger particle size. Specifically, even if there is the toner having the smaller particle size and the circularity close to the sphere being left over on the photosensitive drums due to failures of the blades 27 for the respective colors to scrape the toner off at the time of image formation, the toner will be scraped off together with the black toner having the larger amounts of the abrasive and the lubricant and having the larger particle size as well as irregular circularity.

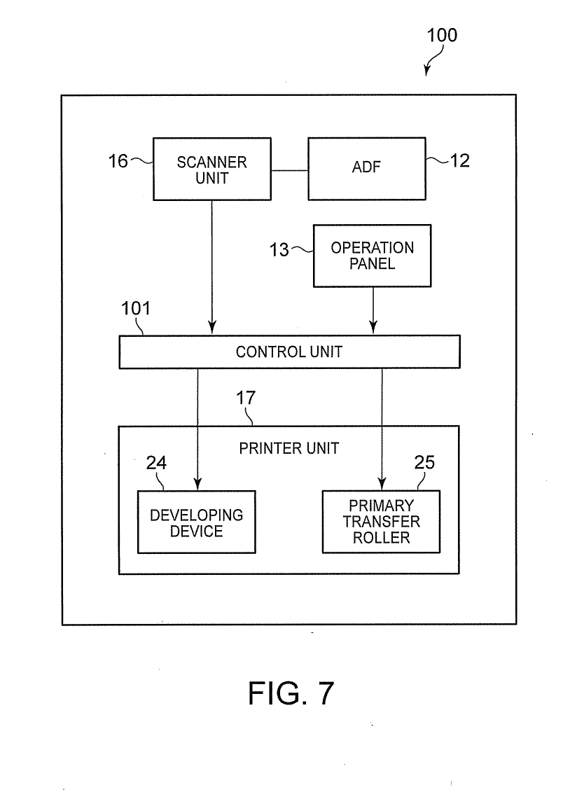

FIG. 7 is a block diagram showing a control system of the MFP 100, which mainly depicts a control system for a developing apparatus 50.

In FIG. 7, a control unit 101 includes a CPU, a memory (a storage unit), and the like and controls overall operations of the MFP 100. An operation panel 13, a scanner unit 16, and a printer unit 17 are connected to the control unit 101, respectively. As shown in FIG. 2, each of the image forming units 20 of the printer unit 17 includes the photosensitive drum 22 serving as the image carrier, and the charger 23, the developing device 24, the primary transfer roller 25, the clearer 26, and so forth are arranged around the photosensitive drum 22. The control unit 101 changes the bias of the developing device 24 (the development bias) and the bias of the primary transfer roller 25 (the transfer bias) between the primary transfer process and the reverse transfer process. For example, the control unit 101 performs control as follows: the number of printed sheets is counted by the memory included in the control unit 101; on the basis of the count, the black toner is transferred to the intermediate transfer belt 21; thereafter, the black toner is reversely transferred from the intermediate transfer belt 21 to the photosensitive drums 22Y, 22C, and 22M of the image forming units other than the black image forming unit; and the reversely transferred toner is supplied to the cleaning units.

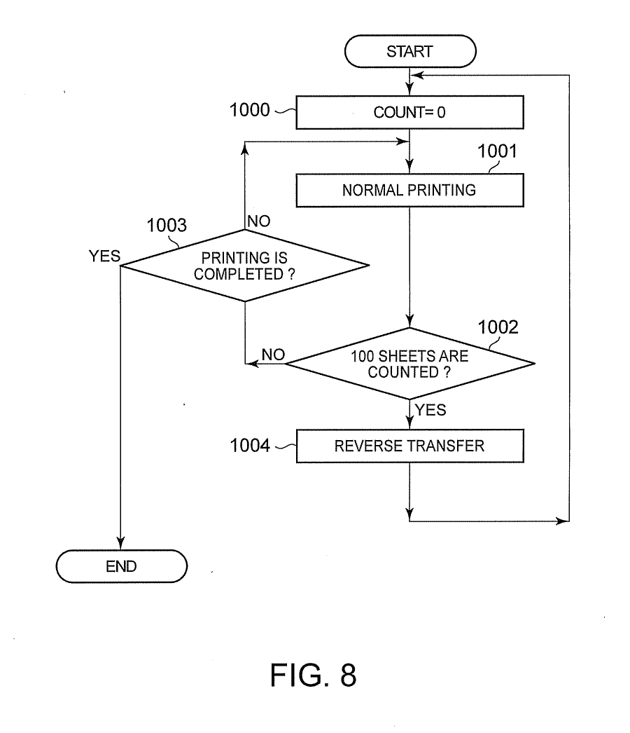

A timing of the reverse transfer of the black toner will be described below. FIG. 8 is a flowchart showing the reverse transfer timing.

First, the count of the number of printed sheets is 0 in step 1000. Then, in step 1001, the sheet S is printed by applying thereto the development bias and the transfer bias for normal printing. The number of printed sheets is counted by the memory in the control unit 101. The development bias at the time of normal printing is −400 V and the transfer bias is 1000 V.

Next, in step 1002, a judgment is made as to whether or not the count of the number of printed sheets is 100. If the count of the number of printed sheets is not 100 (No in step S1002), a judgment is made in step 1003 as to whether or not printing is completed. If printing is completed (Yes in step 1003), the process is terminated. If printing is not completed (No in step 1003), the process goes back to step 1001 and normal printing is executed.

When the count of the number of printed sheets is 100 (Yes in step 1002), the reverse transfer process is executed in step 1004 in which the black toner is transferred to the intermediate transfer belt 21 and then the black toner on the intermediate transfer belt 21 is reversely transferred to the photosensitive drums 22Y, 22C, and 22M of the image forming units other than the black image forming unit. After the reverse transfer, the process goes back to step 1000 in which the count of the number of printed sheets is reset to 0. The process is repeated until printing is completed (Yes in step 1003).

Although the judgment as to whether or not the count of the number of printed sheets is 100 in step 1002, the count here is not limited only to 100 and may be defined to any other values. Instead of reversely transferring the certain amount of the black toner per unit number of sheets as described above, the black toner may be reversely transferred every time one print job is completed. Alternatively, in the case of printing more than a printing threshold, for example 500 sheets, of one print job, image formation may be interrupted at a point of printing 500 sheets even if that point is in the middle of the print job, and the image formation may be resumed after the reverse transfer of the black toner.

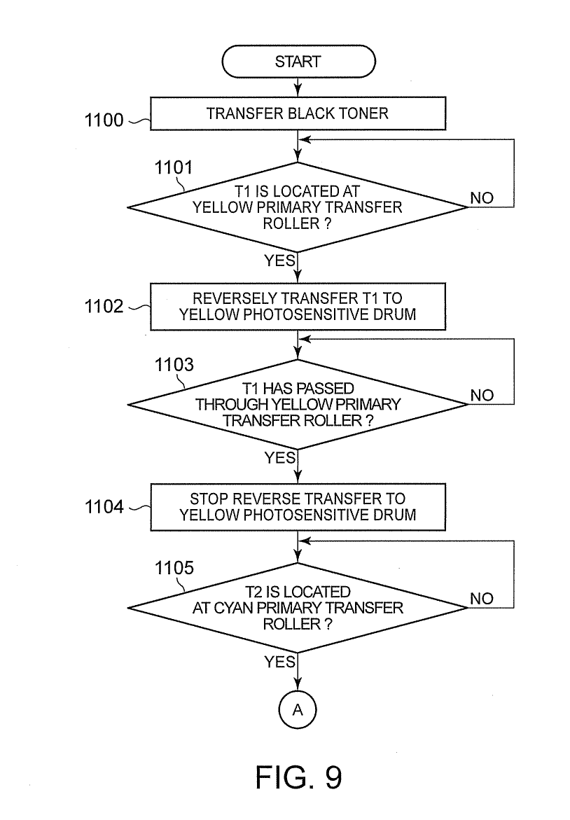

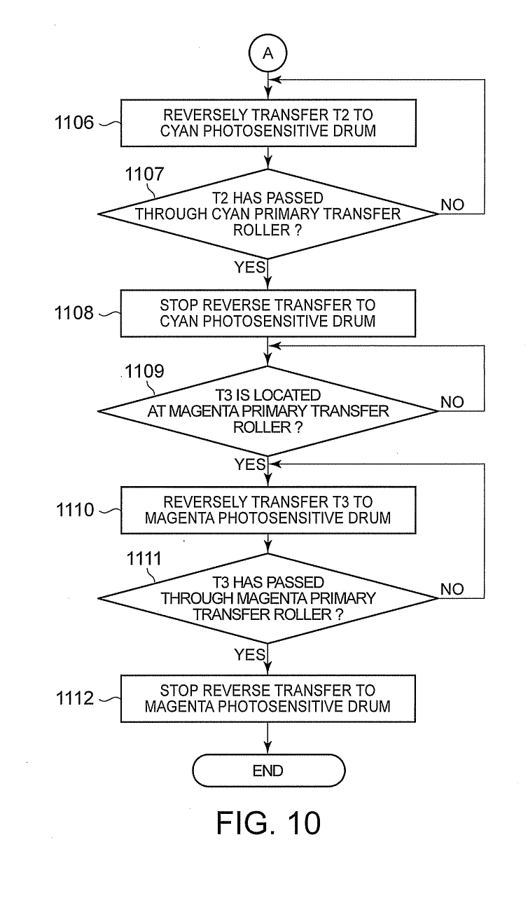

Next, the reverse transfer will be described. FIG. 9 and FIG. 10 are flowcharts showing the reverse transfer. First, in step 1100, the black toner is transferred from the black image forming unit 20K to the intermediate transfer belt 21. The amount of transfer of the black toner to the intermediate transfer belt 21 is about 3 cm in a direction of conveyance of the toner transferred to the intermediate transfer belt 21 (the moving direction of the intermediate transfer belt 21), for example. The development bias and the transfer bias at this time are similar to those of normal printing.

After the transfer of the black toner, a judgment is made in step 1101 as to whether or not the black toner T1 on the intermediate transfer belt 21 is located in a position contacting the yellow primary transfer roller 25Y. When the black toner T1 is located in the position contacting the yellow primary transfer roller 25Y (Yes in step 1101), the black toner T1 is reversely transferred to the yellow photosensitive drum 22Y in step 1102. At the time of the reverse transfer, the development bias is 0 V so as not to transfer the yellow toner to the photosensitive drum 22Y while the transfer bias is −400 V so as to reversely transfer the black toner T1 to the yellow photosensitive drum 22Y.

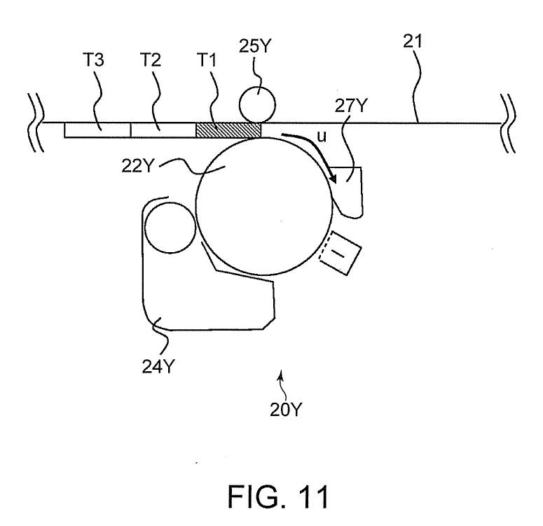

FIG. 11 is a view showing the reverse transfer of the black toner to the yellow photosensitive drum. Reference numerals T1, T2, and T3 shown in FIG. 11 denote the black toner transferred from the black image forming unit 20K to the intermediate transfer belt 21. The transferred black toner has a length of about 3 cm in the direction of conveyance of the toner transferred to the intermediate transfer belt 21. The length of each of T1, T2, and T3 is about 1 cm. At the time of the reverse transfer, the black toner T1 is reversely transferred to the yellow photosensitive drum 22Y, then is conveyed in a direction of an arrow u along with rotation of the photosensitive drum 22Y, and is thus supplied to the blade 27Y.

Next, in step 1103 in FIG. 9, a judgment is made as to whether or not the black toner T1 passes by the yellow primary transfer roller 25Y. When the black toner T1 does not pass by the yellow primary transfer roller 25Y (No in step 1103), the process goes back to step 1102.

When the black toner T1 passes by the yellow primary transfer roller 25Y (Yes in step 1103), the reverse transfer of the black toner T1 to the yellow photosensitive drum 22Y is stopped in step 1104. The reverse transfer of the black toner T1 to the yellow photosensitive drum 22Y is stopped by changing the transfer bias at the time of the reverse transfer from −400 V to 0 V.

After the reverse transfer of the black toner T1 is stopped, a judgment is made in step 1105 as to whether or not the black toner T2 on the intermediate transfer belt 21 is located in a position contacting the cyan primary transfer roller 25C. When the black toner T2 does not contact the cyan primary transfer roller 25C (No in step 1105), the judgment is repeated until the toner T2 contacts the cyan primary transfer roller 25C.

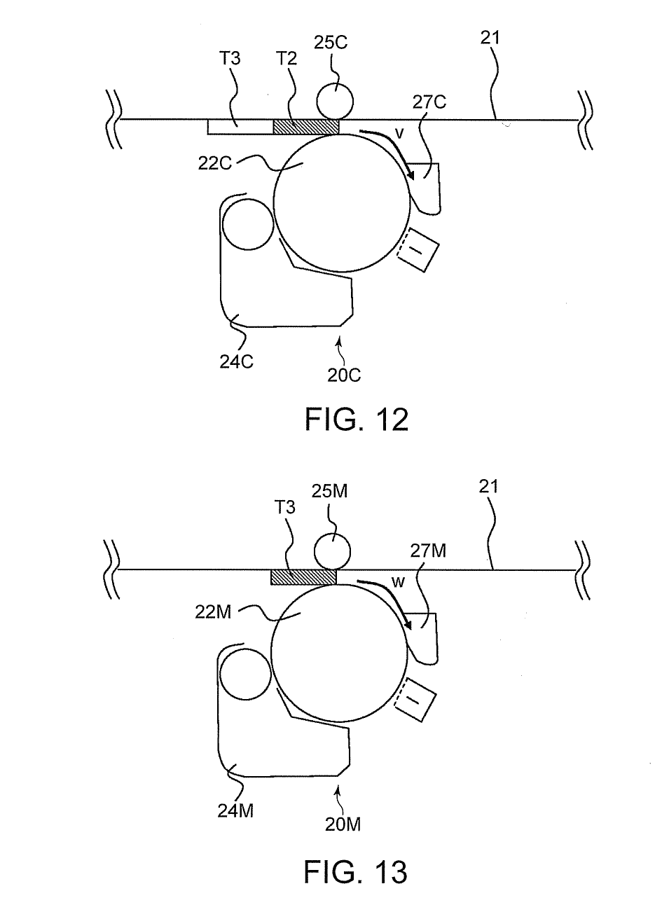

When the black toner T2 contacts the cyan primary transfer roller 25C (Yes in step 1105), the black toner T2 is reversely transferred to the cyan photosensitive drum 22C in step 1106 in FIG. 10. FIG. 12 is a view showing the reverse transfer of the black toner to the cyan photosensitive drum 22C. At the time of the reverse transfer, the development bias is 0 V so as not to transfer the cyan toner to the photosensitive drum 22C while the transfer bias is −400 V so as to reversely transfer the black toner T2 to the cyan photosensitive drum 22C. As shown in FIG. 12, the black toner T2 is reversely transferred to the cyan photosensitive drum 22C, then is conveyed in a direction of an arrow v along with rotation of the photosensitive drum 22C, and is thus supplied to the blade 27C.

In step 1107 in FIG. 10, a judgment is made as to whether or not the black toner T2 passes by the cyan primary transfer roller 25C. When the black toner T2 does not pass by the cyan primary transfer roller 25C (No in step 1107), the process goes back to step 1106.

When the black toner T2 passes by the cyan primary transfer roller 25C (Yes in step 1107), the reverse transfer of the black toner T2 to the cyan photosensitive drum 22C is stopped in step 1108. The reverse transfer of the black toner T2 to the cyan photosensitive drum 22C is stopped by changing the transfer bias at the time of the reverse transfer from −400 V to 0V.

After the reverse transfer of the black toner T2 is stopped, a judgment is made in step 1109 as to whether or not the black toner T3 on the intermediate transfer belt 21 is located in a position contacting the magenta primary transfer roller 25M. When the black toner T3 does not contact the magenta primary transfer roller 25M (No in step 1109), the judgment is repeated until the toner T3 contacts the magenta primary transfer roller 25M.

When the black toner T3 contacts the magenta primary transfer roller 25M (Yes in step 1108), the black toner T3 is reversely transferred to the magenta photosensitive drum 22M in step 1110. FIG. 13 is a view showing the reverse transfer of the black toner on the intermediate transfer belt 21 to the magenta photosensitive drum 22M. At the time of the reverse transfer, the development bias is 0 V so as not to transfer the magenta toner to the photosensitive drum 22M while the transfer bias is −400 V so as to reversely transfer the black toner T3 to the magenta photosensitive drum 22M. As shown in FIG. 13, the black toner T3 is reversely transferred to the magenta photosensitive drum 22M, then is conveyed in a direction of an arrow w along with rotation of the photosensitive drum 22M, and is thus supplied to the blade 27M.

In step 1111 in FIG. 10, a judgment is made as to whether or not the black toner T3 passes by the magenta primary transfer roller 25M. When the black toner T3 does not pass by the magenta primary transfer roller 25M (No in step 1111), the process goes back to step 1110.

When the black toner T3 passes by the magenta primary transfer roller 25M (Yes in step 1111), the reverse transfer of the black toner T3 to the magenta photosensitive drum 22M is stopped in step 1112. The reverse transfer of the black toner T3 to the magenta photosensitive drum 22M is stopped by changing the transfer bias at the time of the reverse transfer from −400 V to 0 V.

In the above description, the black toner is transferred to the intermediate transfer belt 21 and then the toner is divided into three portions of T1, T2, and T3 and then transferred to the photosensitive drums 22Y, 22C, and 22M for the respective colors. However, the present invention is not limited only to this configuration. For example, it is also possible to reversely transfer ⅓ of the black toner to each of the photosensitive drum 22Y, 22C, and 22M for the respective colors by setting the transfer bias for the yellow photosensitive drum 22Y to −200 V, the transfer bias for the cyan photosensitive drum 22C to −300 V, and the transfer bias for the magenta photosensitive drum 22M to −400 V, respectively at the time of the reverse transfer.

Moreover, in the above description, the black toner of about 1 cm in the direction of conveyance of the toner on the intermediate transfer belt 21 is transferred to the image forming unit for each color at the time when the number of printed sheets reaches 100. Instead, it is also possible to change the width of the black toner to be transferred onto the intermediate transfer belt 21 depending on the count of the number of sheets to start the reverse transfer. For example, it is also possible to transfer the black toner of about 5 cm in the direction of conveyance of the toner on the intermediate transfer belt 21 to the image forming unit of each color when the number of printed sheets reaches 500.

In the first embodiment as described above, the toner having the large amounts of the abrasive and the lubricant, the large particle size, and the irregular shape migrates from the black image forming unit 20K to the intermediate transfer belt 21; when the toner reaches the yellow, cyan, and magenta image forming units 20Y, 20C, and 20M, the transfer bias having the opposite polarity to the bias at the time of printing is applied so as to reversely transfer the toner from the intermediate transfer belt 21 to the respective photosensitive drums 22; and thereby the toner is supplied to the respective blades 27. The black toner having the large amounts of the abrasive and the lubricant remains in the vicinity of a tip end of each blade or is scraped off with the blade 27. In this way, the toner can be prevented from passing by the cleaning blade or adhering to the photosensitive drum.

When the amount of the lubricant is large, there sometimes arises a problem that a toner charge amount is unstable. However, in the first embodiment, the black toner is used as the toner for a first image forming unit. If a development amount reduces due to the increase of the lubricant in any color toner (yellow, cyan or magenta), color texture in a color image may vary and an influence may become conspicuous. However, when the black toner is used, it is possible to reduce the conspicuity of the color texture and thereby to minimize the influence of the increase in the amount of the lubricant.

Meanwhile, the toner having the circularity close to the sphere and having small particle sizes can form images with favorable image quality. In the first embodiment, the yellow, cyan, and magenta image forming units use the toner having the circularity close to the sphere and having the small particle sizes. That is, it is possible to prevent degradation in the cleaning performance and to prevent adhesion of the toner to the photosensitive drums while forming images with favorable image quality.

### Second Embodiment

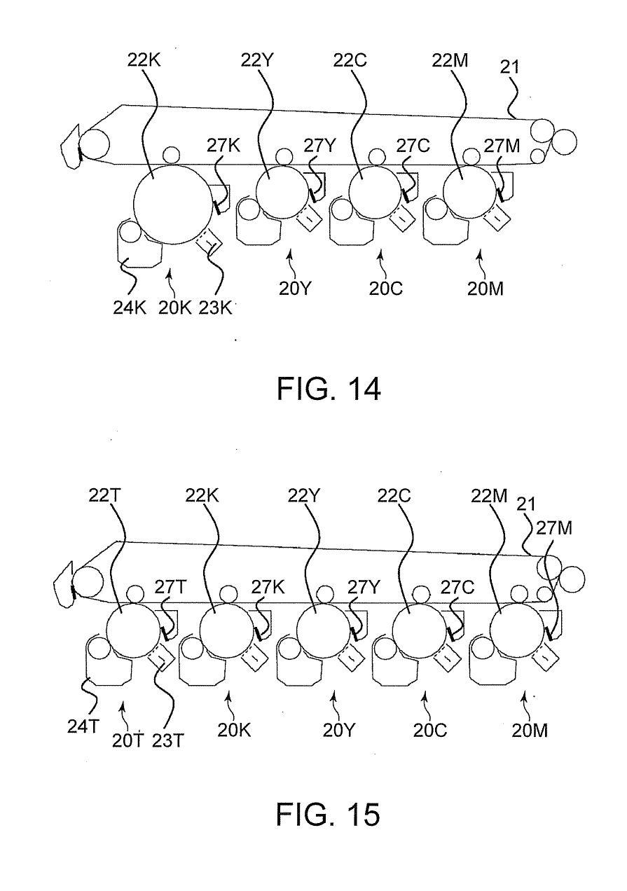

A second embodiment shown in FIG. 14 provides the tandem-type image forming apparatus, in which the photosensitive drum of the black image forming unit 20K has a larger diameter than the photosensitive drums of the other image forming units. The toner characteristics of the black image forming unit 20K are different from the toner characteristics of the yellow, cyan, and magenta image forming units, and the toner of the black image forming unit is reversely transferred to the photosensitive drums of the other image forming units. This embodiment is different from the first embodiment in that the photosensitive drum of the black image forming unit has the larger diameter. In the drawing, the same constituents as those in the first embodiment are designated by the same reference numerals.

FIG. 14 is a configuration diagram showing an internal structure of the MFP 100 according to the second embodiment. As shown in FIG. 14, the photosensitive drum 22 of the black image forming unit 20K has the large diameter.

When the amount of the abrasive is large, there sometimes arises a problem that the photosensitive drum contacting the toner having the large amount of the abrasive at the time of normal printing has a shorter product life due to detachment of a film on the photosensitive drum. On the other hand, such a decrease in the product life can be prevented by increasing the diameter of the photosensitive drum 22K of the black image forming unit 20K.

According to the image forming apparatus having the above-described configuration, it is possible to prevent the toner from passing by the cleaning blade or adhering to the photosensitive drum while forming images with favorable image quality. Moreover, it is possible to prevent a decrease in the product life of the photosensitive drum.

### Third Embodiment

A third embodiment shown in FIG. 15 provides the tandem-type image forming apparatus, which further includes another image forming unit (a 0-th image forming unit) located on an upper stream side of the black image forming unit in the moving direction of the intermediate transfer belt. The 0-th image forming unit is not related to printing images on the sheets. Here, the toner of the 0-th image forming unit has similar characteristics to those of the toner of the black image forming unit of the first embodiment. In the drawing, the same constituents as those in the first embodiment are designated by the same reference numerals.

FIG. 15 is a configuration diagram showing an internal structure of the MFP 100 according to the third embodiment. Apart from the black, yellow, cyan, and magenta image forming units 20K, 20Y, 20C, and 20M, the MFP 100 includes a 0-th image forming unit 20T which is not related to image formation for printing. The 0-th image forming unit 20T includes a photosensitive drum 22T, a charger 23T, a developing device 24T, and a blade 27T.

Toner characteristics of the 0-th image forming unit 20T represent grinded toner in irregular shapes, which has large amounts of the abrasive and the lubricant and has a large particle size. On the other hand, the toner characteristics of the black, yellow, cyan, and magenta image forming units represent polymerized toner, which has small amounts of the abrasive and the lubricant, has a small particle size, and has a roughly spherical shape. As similar to the first embodiment, it is also possible to select and to combine some of the above-described characteristics instead of totally changing the amount of the abrasive, the amount of the lubricant, the toner particle size, the toner circularity, and the toner type.

Alternatively, it is possible to transfer the toner of about 1 cm of a moving margin of the intermediate transfer belt 21 from the 0-th image forming unit 20T to each of the image forming units for the respective colors after the printing of 100 sheets. The toner of about 4 cm is transferred from the 0-th image forming unit 20T to the intermediate transfer belt 21 and the transferred toner of about 1 cm is reversely transferred to each of the photosensitive drums of the image forming units for the respective colors.

According to the image forming apparatus having the above-described configuration, it is possible to prevent the toner from passing by the cleaning blade or adhering to the photosensitive drum while forming images with more favorable image quality.

### Fourth Embodiment

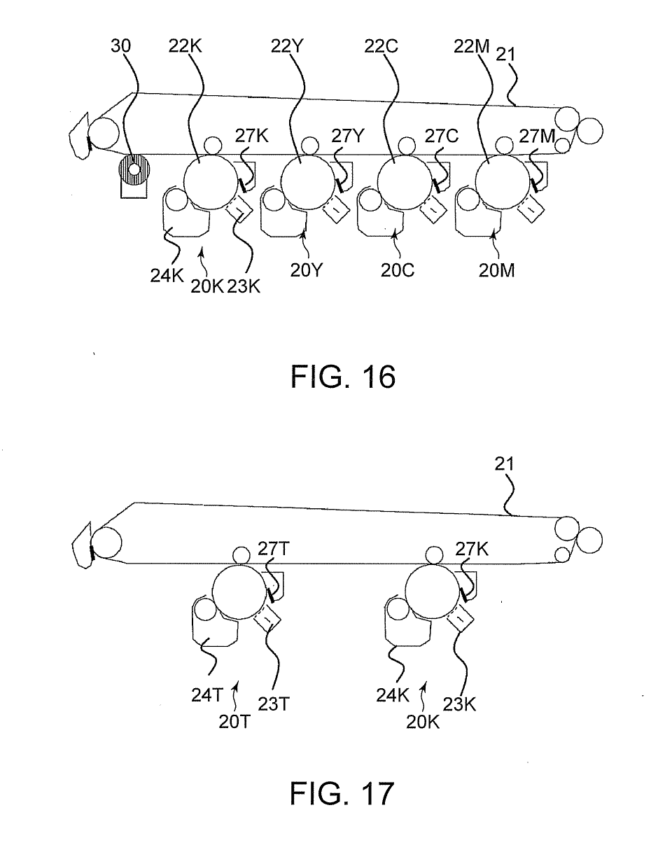

A fourth embodiment shown in FIG. 16 provides the tandem-type image forming apparatus, which further includes a supply unit configured to supply toner in which at least one of an abrasive and a lubricant has a larger amount than the toner of the image forming units for the respective colors, instead of providing the 0-th image forming unit of the third embodiment. In the drawing, the same constituents as those in the first embodiment are designated by the same reference numerals.

FIG. 16 is a configuration diagram showing an internal structure of the MFP 100 according to the fourth embodiment. A supply unit 30 is provided on an upstream side in the moving direction of the intermediate transfer belt 21 (the direction of conveyance of the toner) of the image forming units 20K, 20Y, 20C, and 20M for the respective colors. Specifically, the supply unit 30 is located in the position where the 0-th image forming unit is provided in the third embodiment.

The supply unit 30 is formed of a rotatable brush or roller. While being always in contact with the intermediate transfer belt 21, the supply unit 30 is configured to gradually supply the toner in which at least one of an abrasive and a lubricant has a larger amount by way of rotation. The toner to be supplied from this supply unit 30 is used only for cleaning the photosensitive drums 22 for the respective colors.

The brush or the roller of the supply unit 30 may be configured to be always in contact with the intermediate transfer belt 21 as described above, or may be configured to be movable by use of a solenoid and to supply the toner every time a job is completed. For example, the solenoid is turned on when the job is completed, and thereby the supply unit 30 is lifted up so as to contact the intermediate transfer belt 21 and the toner is supplied in the amount of 4 cm of the moving margin of the intermediate transfer belt 21. After the toner is supplied, the solenoid is turned off to move the supply unit 30 down.

Alternatively, it is possible to transfer the toner of about 1 cm of the moving margin of the intermediate transfer belt 21 to each of the image forming units for the respective colors after the printing of 100 sheets.

According to the image forming apparatus having the above-described configuration, it is possible to prevent the toner from passing by the cleaning blade or adhering to the photosensitive drum while forming images with more favorable image quality. Moreover, the supply unit does not require a large space as compared to the 0-th image forming unit of the third embodiment. Therefore, it is possible to downsize the image forming apparatus.

### Fifth Embodiment

In a fifth embodiment shown in FIG. 17, when the tandem-type color image forming apparatus is changed into a monochrome image forming apparatus, two image forming units are left instead of only one, and the image forming unit located on the upstream in the moving direction of the intermediate transfer belt is used as the 0-th image forming unit as similar to the third embodiment. In the drawing, the same constituents as those in the first embodiment are designated by the same reference numerals.

FIG. 17 is a configuration diagram showing an internal structure of the MFP 100 according to the fifth embodiment. For example, the image forming unit on the upstream side is the 0-th image forming unit 20T while the mage forming unit on the downstream side is the black image forming unit (the black toner) 20K. The toner here is not limited only to the black toner and any toner in different colors is usable.

Toner characteristics of the 0-th image forming unit 20T represent grinded toner in irregular shapes, which has larger amounts of the abrasive and the lubricant and has a larger particle size than the toner of the image forming unit 20K. On the other hand, toner characteristics of the image forming unit 20K represent polymerized toner, which has small amounts of the abrasive and the lubricant, has a small particle size, and has a roughly spherical shape. As similar to the first embodiment, it is also possible to select and to combine some of the above-described characteristics instead of totally changing the amount of the abrasive, the amount of the lubricant, the toner particle size, the toner circularity, and the toner type.

In this embodiment, it is also possible to transfer the toner of about 1 cm of the moving margin of the intermediate transfer belt 21 from the 0-th image forming unit 20T to the image forming unit 20K after the printing of 100 sheets.

According to the image forming apparatus having the above-described configuration, it is possible to prevent the toner from passing by the cleaning blade or adhering to the photosensitive drum while forming images with more favorable image quality. Moreover, when the tandem-type color image forming apparatus is changed into the monochrome image forming apparatus, cost reduction is possible because one extra image forming unit is left to be changed into the 0-th image forming unit.

While certain embodiments have been described, those embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cove such forms or modifications as would fall within the scope and spirit of the inventions.

What is claimed is:

1. An image forming apparatus comprising:
a first image forming unit including an image carrier, a developing device configured to develop an electrostatic latent image formed on the image carrier and to form a toner image on the image carrier, and a first cleaning unit configured to remove residual toner on the image carrier;
a second image forming unit including an image carrier, a developing device having toner in which an external additive has a larger amount than in toner in the developing device of the first image forming unit, the developing device configured to develop an electrostatic latent image formed on the image carrier and to form a toner image on the image carrier, and a second cleaning unit configured to remove residual toner on the image carrier;
a transfer body facing the first and second image forming units and configured to convey the toner images transferred respectively from the image carriers at the time of executing a printing process; and
a control unit configured to control to transfer the toner image from the image carrier of the second image forming unit to the transfer body at a timing other than the printing process, to reversely transfer the transferred toner image to the image carrier of the first image forming unit, and to supply the reversely transferred toner to the first cleaning unit.

2. The image forming apparatus according to claim 1, wherein
the toner of the second image forming unit has a black color, and
the second image forming unit is located upstream of the first image forming unit in a direction of conveyance of the toner image by the transfer body.

3. The image forming apparatus according to claim 1, wherein a plurality of the first image forming units are arranged in the direction of conveyance of the toner image by the transfer body.

4. The image forming apparatus according to claim 1, wherein
the image carriers of the first and second image forming units are photosensitive drums, and
the photosensitive drum of the second image forming unit has a larger diameter than the photosensitive drum of the first image forming unit.

5. The image forming apparatus according to claim 1, wherein
the control unit includes a storage unit configured to count the number of printed sheets, and
when the number counted by the storage unit is larger than a threshold, the toner image transferred from the image carrier of the second image forming unit to the transfer body is reversely transferred to the image carrier of the first image forming unit.

6. The image forming apparatus according to claim 1, wherein
the toner in the developing device of the second image forming unit has a larger toner particle size than the toner in the developing device of the first image forming unit.

7. The image forming apparatus according to claims 1, wherein
the toner in the developing device of the second image forming unit has a smaller circularity than the toner in the developing device of the first image forming unit.

8. The image forming apparatus according to claim 1, wherein
the external additive is at least one of an abrasive or a lubricant.

9. An image forming apparatus comprising:
an image forming unit including, an image carrier, a developing device configured to develop an electrostatic latent image formed on the image carrier and to form a toner image on the image carrier, and a cleaning unit configured to remove residual toner on the image carrier;
a transfer body facing the image forming unit and configured to convey the toner image transferred from the image carrier of the image forming unit at the time of executing a printing process;
a supply unit having toner in which an external additive has a larger amount than in toner in the developing device of the image forming unit and which is configured to supply the toner to the transfer body; and
a control unit configured to control to supply the toner in the supply unit to the transfer body at a timing other than the printing process, to reversely transfer the supplied toner to the image carrier of the image forming unit, and to supply the reversely transferred toner to the cleaning unit.

10. The image forming apparatus according to claim 9, wherein
a plurality of the image forming units are arranged in a direction of conveyance of the toner image by the transfer body.

11. The image forming apparatus according to claim 9, wherein
the external additive is at least one of an abrasive or a lubricant.

12. The image forming apparatus according to claim 9, wherein
the toner in the supply unit has a larger toner particle size than the toner in the developing device of the image forming unit.

13. The image forming apparatus according to claims 9, wherein
the toner in the supply unit has a smaller circularity than the toner in the developing device of the first image forming unit.

14. A toner supplying method for an image forming apparatus including a first image forming unit having first toner, a supply unit having second toner in which an external additive has a larger amount than the first toner and a transfer body configured to be able to carry the first toner or the second toner, the method comprising the step of:
transferring the second toner in the supply unit to the transfer body
transferring reversely the transferred second toner from the transfer body to the first image forming unit at a timing other than a normal printing process.

15. The toner supplying method according to claim 14, wherein
the supply unit is a second image forming unit having the second toner, and the second toner in the second image forming unit is supplied to the first image forming unit via the transfer body.

16. The toner supplying method according to claim 15 further comprising,
forming toner image on the transfer body by using the first toner of the first image forming unit during the normal printing process.

17. The toner supplying method according to claim 16 further comprising,
transferring the second toner in the second image forming unit to the transfer body, after forming the toner image at a predetermined number in the normal printing process.

18. The toner supplying method according to claim 17 further comprising,
after the second toner is reversely transferred to the first image forming unit, conveying the reverse transferred second toner into a cleaning unit.

19. The toner supplying method according to claim 16 further comprising,
forming black toner image on the transfer body by using the second toner in the normal printing process,
wherein the first toner of the first image forming unit is used for a color image forming process.

20. The toner supplying method according to claim 18, wherein
the image forming apparatus has a plurality of the first image forming units, a part of the transferred second toner on the transfer body is reversely transferred to one of the first image forming units and a rest of the transferred second toner on the transfer body is reversely transferred to other of the first image forming units.
